(19) United States
(12) Patent Application Publication
(10) Pub. No.: US 2024/0163854 A1
(43) Pub. Date: May 16, 2024

(54) METHOD AND SYSTEM FOR TRANSMISSION RESOURCE INDICATION

(71) Applicant: ZTE CORPORATION, Shenzhen (CN)

(72) Inventors: Xing LIU, Shenzhen (CN); Xianghui HAN, Shenzhen (CN); Xingguang WEI, Shenzhen (CN); Jing SHI, Shenzhen (CN)

(73) Assignee: ZTE CORPORATION, Shenzhen (CN)

(21) Appl. No.: 18/520,209

(22) Filed: Nov. 27, 2023

Related U.S. Application Data
(63) Continuation of application No. PCT/CN22/87632, filed on Apr. 19, 2022.

(51) Int. Cl. H04W 72/0446

(52) U.S. Cl. CPC H04W 72/0446

(57) ABSTRACT

The present disclosure is directed to transmission source indication, including configuring, by a base station for a wireless communication device, a time-domain window, where the time-domain window is defined by at least one of a period of the time-domain window, an offset for the time-domain window, a length of the time-domain window, a duration of the time-domain window, a starting of the time-domain window, or a time domain pattern of the time-domain window, communicating, by the base station with the wireless communication device, using the time-domain window.

### CROSS-REFERENCE TO RELATED APPLICATION

This application claims the benefit of priority under 35 U.S.C. § 120 as a continuation of International Patent Application No. PCT/CN2022/087632, filed on Apr. 19, 2022, the disclosure of which is incorporated herein by reference in its entirety.

### TECHNICAL FIELD

The disclosure relates generally to wireless communications and, more particularly, to systems, methods, and non-transitory computer-readable media for transmission source indication.

### BACKGROUND

Fourth Generation mobile communication technology (4G) Long-Term Evolution (LTE) or LTE-Advance (LTE-A) and the 5th Generation mobile communication technology (5G) face increasing performance demands. In view of these developing demands and trends, it is desired that 4G and 5G systems support features of enhanced mobile broadband (eMBB), ultra-reliable low-latency communication (URLLC), and massive machine-type communication (mMTC). Further, it is further desired to include full duplex communication in 5G and further communication systems.

### SUMMARY

The example arrangements relate to transmission source indication.

Present implementations are directed to a wireless communication device, including configuring, by a base station for a wireless communication device, a time-domain window, where the time-domain window is defined by at least one of a period of the time-domain window, an offset for the time-domain window, a length of the time-domain window, a duration of the time-domain window, a starting of the time-domain window, or a time domain pattern of the time-domain window, communicating, by the base station with the wireless communication device, using the time-domain window.

Present implementations can include a communication device, including receiving, by a wireless communication device from a base station, a time-domain window, where the time-domain window is defined by at least one of a period of the time-domain window, an offset for the time-domain window, a length of the time-domain window, a duration of the time-domain window, a starting of the time-domain window, or a time domain pattern of the time-domain window, communicating, by the wireless communication device with the base station, using the time-domain window.

Present implementations can include a wireless communication apparatus including at least one processor and a memory, where the at least one processor is configured to read code from the memory and implement a method in accordance with present implementations.

Present implementations can include a computer program product including a computer-readable program medium code stored thereupon, the code, when executed by at least one processor, causing the at least one processor to implement a method in accordance with present implementations.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3 is a diagram illustrating a first time domain resource, according to various arrangements.

FIG. 4 is a diagram illustrating a first communication in a cell using various frame structures, according to various arrangements.

FIG. 5 is a diagram illustrating a second communication in a cell using various frame structures, according to various arrangements.

FIG. 6 is a signaling diagram illustrating a first cell level frame structure, according to various arrangements.

FIG. 7 is a signaling diagram illustrating a second cell level frame structure, according to various arrangements.

FIG. 8 is a signaling diagram illustrating a third cell level frame structure, according to various arrangements.

FIG. 9 is a signaling diagram illustrating a first configuration of a time domain window, according to various arrangements.

FIG. 10 is a table illustrating example conversions of various frame structures, according to various arrangements.

FIG. 11 is a signaling diagram illustrating a second configuration of a time domain window, according to various arrangements.

FIG. 12 is a signaling diagram illustrating a third configuration of a time domain window, according to various arrangements.

FIG. 13 is a signaling diagram illustrating a fourth cell level frame structure, according to various arrangements.

FIG. 14 is a diagram illustrating an example method for transmission source indication, according to various arrangements.

FIG. 15 is a diagram illustrating an example method for transmission source indication, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

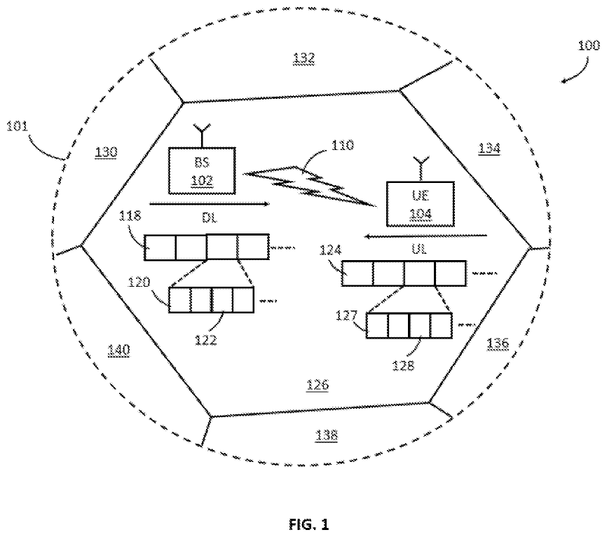

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

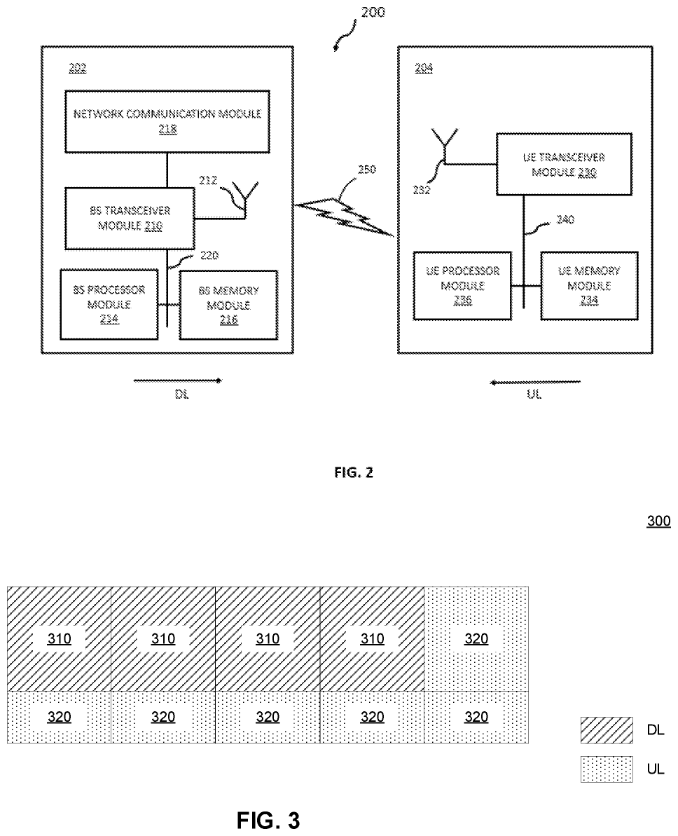

FIG. 3 is a diagram illustrating a first time domain resource, according to various arrangements. As illustrated by way of example in FIG. 3, an example time domain resource 300 can include a plurality of downlink (DL) slots 310 and a plurality of uplink slots 320.

In an example wireless communication system, the time domain resource is split between downlink and uplink in TDD. Allocation of a limited time duration for the uplink in TDD can result in reduced coverage, increased latency and reduced capacity. Simultaneous existence of downlink and uplink, a.k.a. full duplex, or more specifically, subband non-overlapping full duplex at the gNB side within a TDD band, can be advantageous. Uplink and downlink can occur in different frequency domain resources of a same time domain resource. As an example shown in FIG. 1, the first four time intervals (e.g., frames, slots or symbols, etc.), include downlink resources for the first frequency resource, and an uplink resource for the second frequency resource. It is advantageous to configure the time/frequency domain structure under a system supporting full duplex. Present implementations can thus advantageously support this structure.

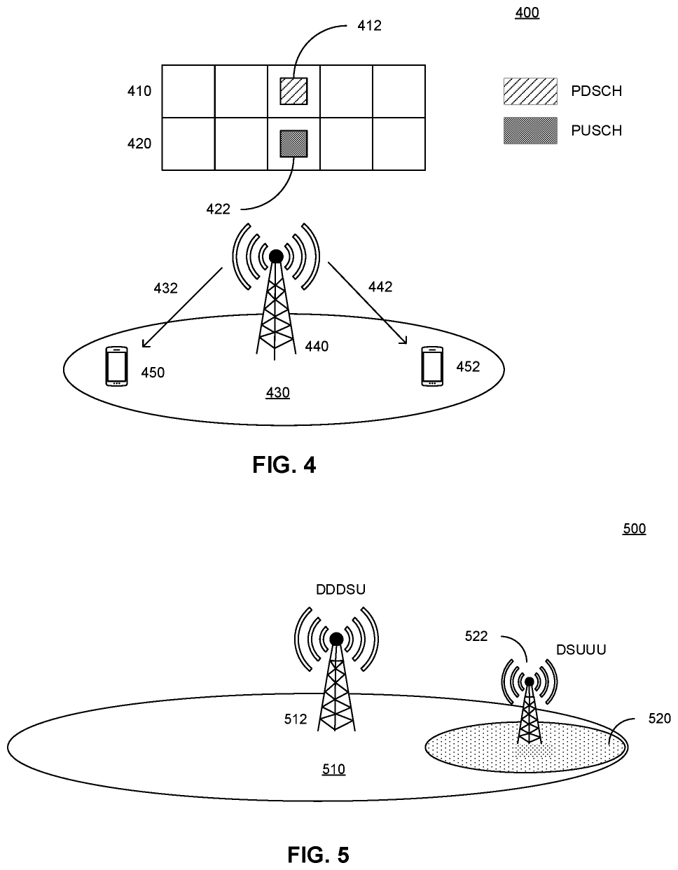

FIG. 4 is a diagram illustrating a first communication in a cell using various frame structures, according to various arrangements. As illustrated by way of example in FIG. 4, an example communication 400 can include a first frame structure 410 and a second frame structure in a cell 430 for the first frequency resource and the second frequency resource, respectively. For the third time interval(e.g., the third slots), there is a PDSCH 412 in the first frequency resource, and a PUSCH 422 in the second frequency resource. The cell 430 can include a first transmission 432 associated with the PDSCH 412 and a second transmission 442 associated with the PUSCH, simultaneously. The first transmission 412 can be from a BS 440 associated with the cell 400 to a first UE 450. The second transmission 422 can be from a second UE 452 to the BS 440 associated with the cell 400.

In some scenarios, adjacent frequency resources within a same carrier or cell can be configured with different attributes, with respect at least to uplink or downlink, during a specific time interval. These configurations can improve resource usage efficiency and data scheduling flexibility, and reduce the conversion delay between uplink and downlink transmission.

FIG. 4 is an example of a same cell under the base station, where there are two different frequency resource with different frame structures. One frame structure is DDDSU, and another is DSUUU. As one example, D represents ‘downlink’, U represents ‘uplink’, and S represents ‘flexible resource.’ One or more can be further updated according to dynamic scheduling or a dynamic frame structure indication (e.g., SFI). During the middle three time intervals (e.g., slot 1, 2, 3 from slot 0-4) can have different attributes between different frequency resources. For different UEs, the base station can transmit PDSCH and receive PUSCH simultaneously.

FIG. 5 is a diagram illustrating a second communication in a cell using various frame structures, according to various arrangements. As illustrated by way of example in FIG. 5, an example communication 500 can include a first cell 510 associated with a macro station 512 and a second cell 520 associated with a micro station 522.

As one example, within the same time domain interval, adjacent base stations deployed at the same frequency can also be configured with different resource attributes, with respect to at least uplink or downlink, so as to meet the resource transmission requirements in specific scenarios. As an example shown in FIG. 5, in the factory automation scenario, the factory area is covered by a micro cell 520 having a large number of uplink transmission requirements. Here, the frame structure is configured as ‘DSUUU.’ However, the macro cell 510 overlapping with the factory area can consider the typical communication requirements. A higher downlink resource ratio is configured, e.g., DDDSU. Similarly, during the middle three time intervals (e.g., slot 1, 2, 3 from slot 0-4) may include different attributes for a same time frequency domain resource between different base stations 522 and 512.

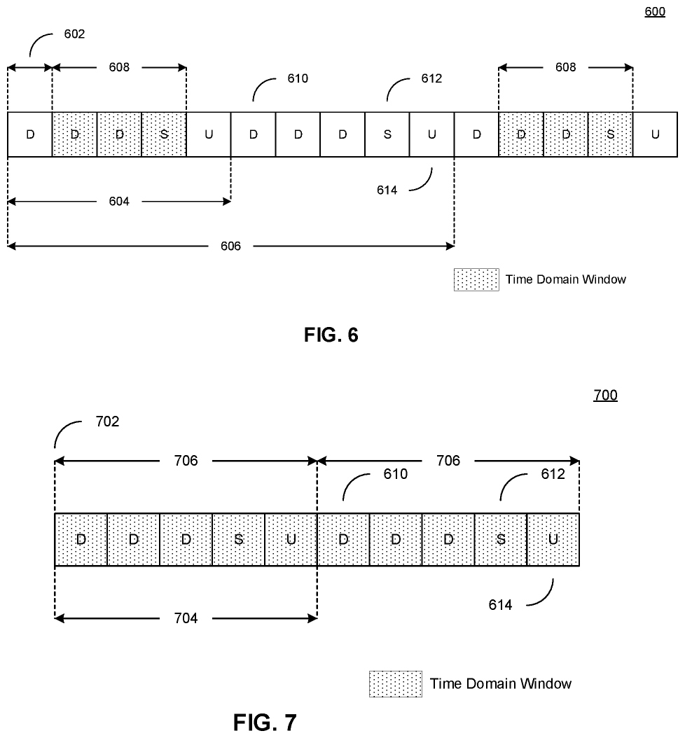

FIG. 6 is a signaling diagram illustrating a first cell level frame structure, according to various arrangements. As illustrated by way of example in FIG. 6, an example frame structure 600 can include a plurality of time intervals (e.g., slots, symbols, frames, etc.) 610, 612 and 614 associated with an offset 602, a frame structure period 604, a time domain period 606, and a plurality of time domain windows 608. Present implementations can configure a time/frequency domain structure under a system supporting full duplex. Present implementations can define resource usage rules.

One example is directed to time domain resource determination for supporting full duplex. Defining a time domain window can include defining specific operations or behaviors. As one example, the time frequency resource structure can be configured according to the time domain window. As another example, different attributes for different frequency resources can only be configured within the time domain window. As another example, an interference measurement operation is defined according to the time domain window. Here, an interference measurement operation can only be performed within the time domain window. As another example, interference management is defined according to the time domain window. Here, interference management related rules or operations can only be performed within the time domain window. As another example, different power control mechanisms can be adopted for uplink transmission within the time domain window and outside of the time domain window, respectively. Here, different open loop power control parameters sets are used for uplink transmission within the time domain window and outside of the time domain window, respectively. Or different closed loop power control parameters(e.g., transmission power control(TPC) tables) are used for uplink transmission within the time domain window and outside of the time domain window, respectively. It is to be understood that the present disclosure is not limited to the above-noted examples.

A time domain window can be configured via at least one of parameters including period, offset, length, duration, and a starting position. The configuration of time domain window can be cell-specific (e.g., a same configuration is valid for the whole cell) or bandwidth part specific (e.g., configured per BWP, and different BWPs can have different configurations) or UE specific (e.g., configured per UE, and different UEs can have different configurations).

Present implementations are directed to a wireless communication device, including configuring, by a base station for a wireless communication device, a time-domain window, where the time-domain window is defined by at least one of a period of the time-domain window, an offset for the time-domain window, a length of the time-domain window, a duration of the time-domain window, a starting of the time-domain window, or a time domain pattern of the time-domain window, communicating, by the base station with the wireless communication device, using the time-domain window.

Present implementations can include a communication device, including receiving, by a wireless communication device from a base station, a time-domain window, where the time-domain window is defined by at least one of a period of the time-domain window, an offset for the time-domain window, a length of the time-domain window, a duration of the time-domain window, a starting of the time-domain window, or a time domain pattern of the time-domain window, communicating, by the wireless communication device with the base station, using the time-domain window.

In some aspects, the time-domain window is determined for a cell.

In some aspects, the time-domain window is defined for a frequency resource.

As an example shown in FIG. 6, the cell level frame structure is configured (e.g., via RRC signaling ‘tdd-UL-DL-ConfigurationCommon’ or via both of ‘tdd-UL-DL-ConfigurationCommon’ and ‘tdd-UL-DL-ConfigurationDedicated’) as ‘DDDSU’ with a period of 5 slots, the time domain window is configured with a period of 10 slots, an offset is configured as 1 slot, and a length is configured as 3 slots. The time domain window can also be configured in terms of symbols or other granularity. As one example, the configuration in FIG. 6 can have a period of 140 symbols, an offset of 14 symbols, and a length of 42 symbols.

In some aspects, the period of the time-domain window is a first number of time intervals, the offset of the time-domain window is a second number of the time intervals from a start of the period of the time-domain window, the length of the time-domain window is a third number of the time intervals. Then, the time-domain window with the third number of the time intervals length begins from the second number of the time intervals after the start of each period of the time-domain window. As one example, the period of the time-domain window is greater than a period of a frame structure. As another example, the length of the time-domain window is within one of the period of the frame structure every two of the period structures. As one example, the period of the time-domain window equals to a period of a frame structure. As one example, the period of the time-domain window is smaller than a period of a frame structure.

FIG. 7 is a signaling diagram illustrating a second cell level frame structure, according to various arrangements. As illustrated by way of example in FIG. 7, an example frame structure 700 can include the plurality of time intervals (e.g., slots, symbols, frames, or the like) 610, 612 and 614 associated with an offset 702, a frame period 704, and a plurality of time domain windows 706.

As an example shown in FIG. 7, the cell level frame structure is configured as ‘DDDSU’ with period of 5 slots, a time domain window with a period equaling the length, and an offset of 0. The frame structure 700 can be configured via RRC signaling ‘tdd-UL-DL-ConfigurationCommon’ or via both of ‘tdd-UL-DL-ConfigurationCommon’ and ‘tdd-UL-DL-ConfigurationDedicated’. For this configuration, the time domain window can cover all of the time domain resources as period is equal to length, regardless of which value of the period or length is configured. In some embodiments, the period, length, and period of cell level frame structure can all be equal to each other. In some embodiments, the offset can be configured with other values.

In some aspects, the period of the time-domain window is a first number of time intervals, and the length of the time-domain window equals to the period of the time-domain window.

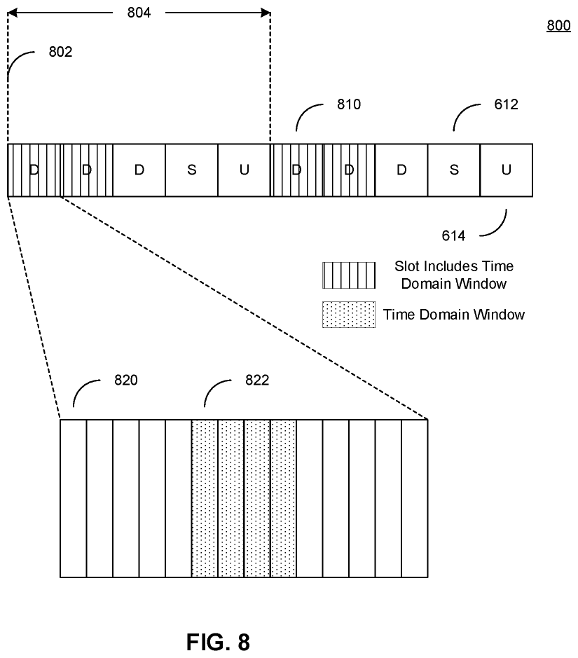

FIG. 8 is a signaling diagram illustrating a third cell level frame structure, according to various arrangements. As illustrated by way of example in FIG. 8, an example frame structure 800 can include the plurality of time intervals(e.g., slots, symbols, frames, etc) 612 and 614 and one or more symbols 820 and 822 associated with a slot that includes a time domain window. The slots 612, 614 and 810 can be associated with an offset 802 and a period of a time domain window 804. The slot 810 can include one or more symbols 820 outside the time domain window, and one or more symbols 822 within the time domain window.

As another example shown in FIG. 8, the cell level frame structure is as ‘DDDSU’ with a period of 5 slots, a time domain window with a period of 5 slots, an offset of 0, a starting symbol(s) within a slot can be indicated by a bitmap with bitwidth equals to symbols number within a slot(i.e., 14) as 0000010 0000000, or a starting symbol within a slot can be indicated by a symbols index as 0110, a length of 4 symbols, and a duration of 2. The frame structure 800 can be configured via RRC signaling ‘tdd-UL-DL-ConfigurationCommon’ or via both of ‘tdd-UL-DL-ConfigurationCommon’ and ‘tdd-UL-DL-ConfigurationDedicated’.

As one example, the starting symbol(s) index within a slot is a bitmap with 14 bits, and the first symbol is indicated via this parameter. The value ‘0000010 0000000’ represents the sixth symbol (e.g., symbol #5 of symbol #0 through #13) within the slot corresponding to the first symbol of the time domain window. As another example, the starting symbol within a slot can be indicated by a symbols index as 0101, which also represents symbol #5(i.e., the sixth symbol within a slot). Where a length of the time domain window is 4 symbols, the time domain window contains symbol #5 through #8 within a slot. As one example, the duration represents how many slots containing the time domain window. A duration of 2 can represent that there are 2 consecutive slots containing the time domain window. The symbols index of a time domain window in each slot is the same.

In some aspects, the period of the time-domain window is a first number of first time intervals, the offset of the time-domain window is a second number of the first time intervals, the starting of the time-domain window within a first time interval is defined by a second time interval index or a bitmap, the length of the time-domain window is a third number of second time intervals, and each of the first time intervals contains a plurality of the second time intervals, the duration of the time-domain window indicates a fourth number of the first time intervals, which contains the time-domain window. As one example, the duration of the time-domain window can include two or more of the first time intervals within the period of the time domain window. As another example, the length of the time-domain window can be within each of the two or more of the first time intervals defining the duration of the time-domain window.

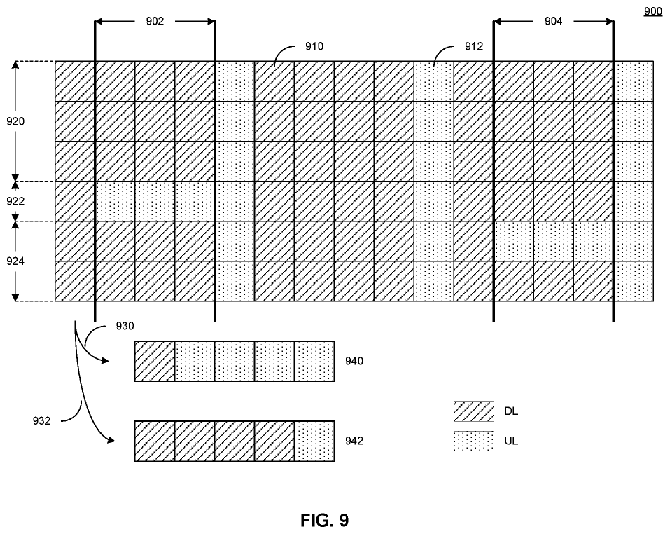

FIG. 9 is a signaling diagram illustrating a first configuration of a time domain window, according to various arrangements. As illustrated by way of example in FIG. 9, an example configuration 900 can include a plurality of time domain windows 902 and 904, a plurality of downlink slots 910, a plurality of uplink slots 912, a first bandwidth part (BWP) 920, a second BWP 922, a third BWP 924, a first frame structure for the second BWP 922, and a second frame structure for the first BWP 920 and the third BWP 924. The first frame structure 940 can be generated by a first conversion 930 based on the configuration 900. The second frame structure 942 can be generated by a second conversion 932 based on the configuration 900.

The time domain window can be configured at least as described above. Further rules are defined for excluding a resource from the configured time domain window. For example, the resource can be excluded if the configured time domain window contains at least one of symbols for transmitting SSB, symbols for a CORESET for TypeO-PDCCH CSS set, symbols for PRACH transmission, symbols for RS transmission, symbols for control channel(e.g., PDCCH, PUCCH) transmission, semi-static uplink resource according to frame structure configuration, semi-static downlink resource according to frame structure configuration, a dynamic uplink resource, a dynamic downlink resource, a dynamic flexible resource. As described above, the time domain window can be defined and used efficiently. In this way, the full duplex working mechanism is advantageously supported in present implementations.

In some aspects, determining the time-domain window includes excluding from the time-domain window one or more of at least one symbol for transmitting Synchronization Signal Block (SSB), at least one symbol for a Control Resource Set (CORESET), at least one symbol for Physical Random Access Channel (PRACH) transmission, at least one symbol for Reference Signal (RS) transmission, at least one symbol for control channel transmission, at least one semi-static uplink resource according to frame structure configuration, at least one semi-static downlink resource according to frame structure configuration, at least one dynamic uplink resource, at least one dynamic downlink resource, or at least one dynamic flexible resource. As one example, the at least one second time domain resource comprises second ones of the resources different from the first ones of the resources.

An example describes on time domain resource determination for supporting full duplex. The time domain window can be determined according to some predefined rules. The rules of time domain window determination can be cell specific (e.g., a same configuration is valid for the whole cell) or bandwidth part specific (e.g., rules are configured per BWP, where different BWPs can have different configurations).

As one example, some types of signals or channels are defined or configured. The time domain window can be determined as the time domain resource excluding the symbols of the above types of signals or channels. As a more detailed example, the SSB is defined by the specification or configured by the base station as a signal/channel mentioned above. Then, a UE can determine the time domain resource for SSB transmission. Here, the time domain window is determined as the time domain resource by excluding the time domain resource for SSB transmission. As one example, the symbols or the slots occupied by SSB are excluded.

As another example, some types of resource attributes are determined as the time domain window. Resource attributes can include one or more of, semi-static downlink, semi-static uplink, semi-static flexible resource, dynamic downlink, dynamic uplink, dynamic flexible resource) The types of resources determined as the time domain window can be defined in the specification or configured by the base station. For example, a semi-static downlink resource is determined as the time domain window. The semi-static downlink resource can be configured via RRC signaling ‘tdd-UL-DL-ConfigurationCommon’ and/or ‘tdd-UL-DL-ConfigurationDedicated.’

As another example, a time domain pattern is configured. For example, the time domain pattern is a on-off pattern. During the phase of ‘on’, the cell level frame structure can be used. The phase of ‘off’ can be defined as the time domain window. The on-off pattern is aligned with DRX on-off pattern of a UE. Thus, the time domain window can be defined and used efficiently. In this way, the full duplex working mechanism is better supported.

In some aspects, the time-domain window is determined as a time domain resource by including at least one first time-domain resource or excluding at least one second time-domain resource.

In some aspects, the at least one second time-domain resource carries a type of signal or channel.

In some aspects, the at least one first time-domain resource includes first ones of resources including a semi-static downlink resource, a semi-static uplink resource, a semi-static flexible resource, a dynamic downlink resource, a dynamic uplink resource, and a dynamic flexible resource.

In some aspects, the time domain pattern includes an ON phase and an OFF phase, a configured frame structure is used during the ON phase, and the time-domain window is defined by the OFF phase.

An example describes using the time domain resource determined for supporting full duplex. The time domain resource can be determined as time domain window. As an example in FIG. 9, the configuration of the time domain window is shown. The frame structure 900 can be configured as DDDDU with period of 5 slots.

For each BWP, an indication can indicate whether to modify the cell level frame structure within the time domain window. For example, the indication is 1 bit. Here, ‘1’ represents that the frame structure within the time domain window follows the cell level frame structure configuration. Here, ‘0’ represents that the frame structure within the time domain window is converted according to the cell level frame structure configuration and some predefined or configured rules. For BWP1 920 and BWP3 924, ‘1’ is indicated. The frame structure within the time domain window follows the cell level frame structure configuration. For BWP2 922, ‘0’ is indicated. The frame structure within the time domain window is converted. For example, one of the rules is defined as converting semi-static downlink to semi-static uplink. Then, the frame structure of BWP2 922 in this frame structure period is modified to ‘DUUUU’.

The method can further include indicating, by the base station to the wireless communication device, whether to modify attributes of time-domain resources of a configured frame structure within the time-domain window with respect to each of a plurality of frequency resources.

The method can further include receiving, by the wireless communication device from the base station, an indication indicating whether to modify attributes of time-domain resources of a configured frame structure within the time-domain window with respect to each of a plurality of frequency resources.

An example describes using the time domain resource determined for supporting full duplex. As an example in FIG. 9, the configuration of the time domain window is shown. The frame structure is configured as DDDDU with a period of 5 slots. For each BWP, another configuration indicates a frame structure within the time domain window. For example, another frame structure can be configured for this BWP, and the configuration can only apply to the resource within time domain windows. If the configuration is absent, the frame structure of this BWP within the time domain window follows the cell level frame structure configuration. Then, for BWP2 922 in FIG. 9, an additional frame structure can be configured as ‘UUU.’ The frame structure of BWP2 922 can be updated to ‘DUUUU’ in this period of cell level frame structure. For BWP1 920 and BWP3 924, this additional frame structure is absent, so the frame structure can follow the cell level frame structure configuration. Thus, the time domain window can be defined and used efficiently. In this way, the full duplex working mechanism is advantageously achieved in present implementations.

The method can further include indicating, by the base station to the wireless communication device, a modified frame structure used within the time-domain window with respect to each of a plurality of frequency resources.

The method can further include receiving, by the wireless communication device from the base station, an indication indicating a modified frame structure used within the time-domain window with respect to each of a plurality of frequency resources.

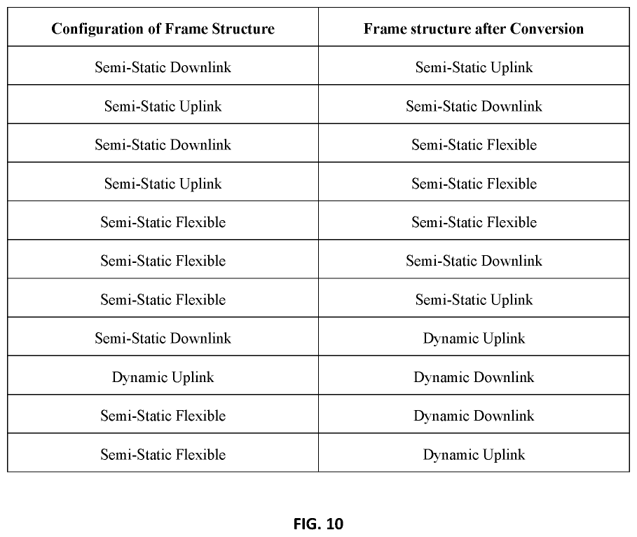

FIG. 10 is a table illustrating example conversions of various frame structures, according to various arrangements. Conversion rules can be defined or configured as at least one the following, and the conversion can be based on the configuration of the frame structure.

Configuration of a frame structure can be accomplished via at least one of, RRC signaling ‘tdd-UL-DL-ConfigurationCommon’ or tdd-UL-DL-ConfigurationDedicated, or dynamic indication ‘e.g., slot format indication(SFI).’ Thus, time domain window can be defined and used efficiently. In this way, the full duplex working mechanism is advantageously achieved in present implementations.

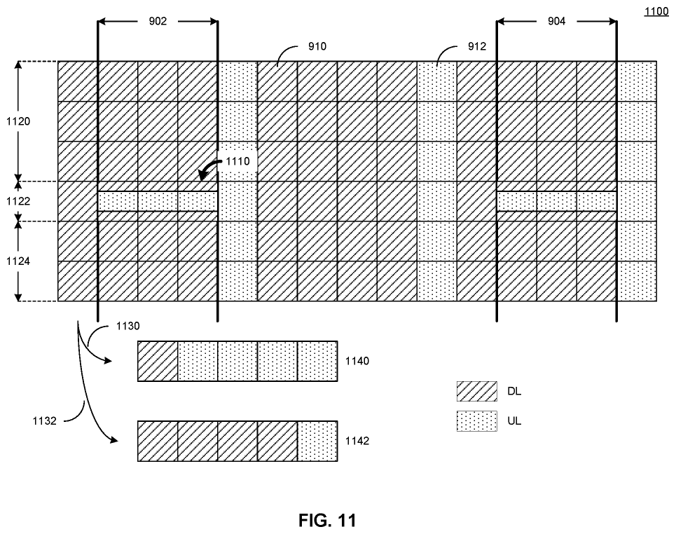

FIG. 11 is a signaling diagram illustrating a second configuration of a time domain window, according to various arrangements. As illustrated by way of example in FIG. 11, an example configuration 1100 can include the plurality of time domain windows 902 and 904, the plurality of downlink slots 910, the plurality of uplink slots 912, a plurality of frequency range 1110, a first BWP 1120, a second BWP 1122, a third BWP 1124, a first frame structure for the frequency range 1110, and a second frame structure for the first BWP 1120 and the third BWP 1124 and frequency resource within the second BWP 1122 and outside of the frequency range 1110. The first frame structure 1140 can be generated by a first conversion 1130 based on the configuration 1100. The second frame structure 1142 can be generated by a second conversion 1132 based on the configuration 1100. The frequency range can include both downlink and uplink components assigned to particular frequency ranges.

An example describes using the time domain resource determined for supporting full duplex. As an example in FIG. 9, the configuration of the time domain window is shown. The frame structure is configured as DDDDU with period=5 slots.

For each BWP, another frequency range can be configured within the BWP as shown in FIG. 11. A frequency range can be configured within the second BWP 1122. There can be another indication for indicating frame structure within the time domain window for the frequency range. Another frame structure can be configured for this frequency range, and the configuration will only be apply to the resource within time domain windows. If the configuration is absent, the frame structure of this frequency range within the time domain window follows the cell level frame structure configuration.

As one example, an indication can indicate whether to modify the cell level frame structure within the time domain window for the frequency range. For example, the indication is 1 bit. Here, ‘1’ represents that the frame structure within the time domain window follows the cell level frame structure configuration. Here, ‘0’ represents that the frame structure within the time domain window can be converted according to the cell level frame structure configuration and some predefined or configured rules. Thus, the time domain window can be defined and used efficiently. In this way, the full duplex working mechanism is advantageously achieved in present implementations.

The method can further include configuring a first frequency resource within a second frequency resource, indicating, by the base station to the wireless communication device, a frame structure used within the time-domain window for the first frequency resource.

The method can further include indicating, by the base station to the wireless communication device, whether to modify attributes of time-domain resources of a configured frame structure within the time-domain window for the first frequency resource.

The method can further include indicating, by the base station to the wireless communication device, a modified frame structure used within the time-domain window for the first frequency resource.

The method can further include receiving, by the wireless communication device from the base station, an indication indicating a first frequency resource within a second frequency resource, receiving, by the wireless communication device from the base station, an indication indicating a frame structure used within the time-domain window for the first frequency resource.

The method can further include receiving, by the wireless communication device from the base station, an indication indicating a modified frame structure used within the time-domain window for the first frequency resource.

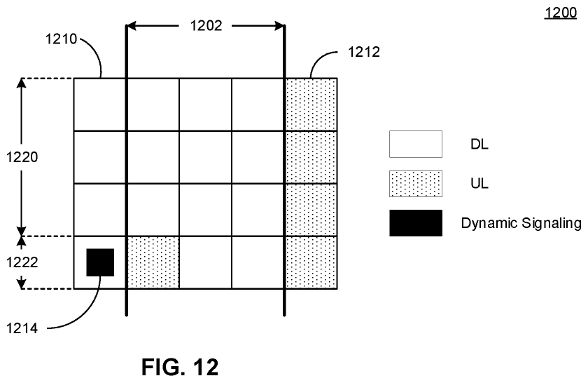

FIG. 12 is a signaling diagram illustrating a third configuration of a time domain window, according to various arrangements. As illustrated by way of example in FIG. 12, an example configuration 1200 can include a time domain window 1202, a plurality of downlink slots 1210, a plurality of uplink slots 1212, one or more dynamic signaling ranges 1214, a first BWP 1220, and a second BWP 1222. It is to be understood that the dynamic signaling range can include at least a portion of one or more of the downlink slots 1210 or the uplink slots 1212, and is not limited to the slots or BWP assignments illustrated in FIG. 12 by way of example.

An example describes using the time domain resource determined for supporting full duplex. A signaling can be used for switching conversion rules during the time domain window. The signaling can include DCI or MAC layer signaling. For example, a time domain window is configured as shown in FIG. 12, and BWP2 is configured to convert the frame structure (e.g., from DL to UL) via RRC signaling. A dynamic signaling can be further received for changing the conversion rule, e.g., to follow the cell level frame structure, or as convert DL to flexible, for example. The new conversion rule can take effect from a time point that a predefined time interval (e.g., a number of symbols, or a number of slots) after receiving the dynamic signaling.

As an example shown in FIG. 12, the cell level frame structure can be configured as DDDDU. Here, there are 3 slots(slot 1-3) within the time domain window, and the frame structure can be converted from DL to UL for BWP2 as configured via RRC signaling. A UE receives a dynamic signaling at slot0 on BWP2. The dynamic signaling indicates the changing the conversion rule, e.g., to follow the cell level frame structure. The new conversion rule can take effect a slot after the dynamic signaling. Thus, slot 1 is converted from DL to UL according to the configuration of RRC signaling. Slot2 and 3 follow the cell level frame structure, e.g., keep DL. The conversion can also be based on dynamic scheduling. for example, if a PDSCH is scheduled on slot 2, then, the frame structure of slot2 or symbols occupied by the PDSCH can be changed to Uplink. Thus, the time domain window can be defined and used efficiently. In this way, the full duplex working mechanism is advantageously achieved in present implementations.

The method can further include sending, by the base station to the wireless communication device, first signaling indicating converting a frame structure within the time-domain window, and sending, by the base station to the wireless communication device, second signaling indicating modifying a conversion rule by which the frame structure is converted.

The method can further include receiving, by the wireless communication device from the base station, first signaling indicating converting a frame structure within the time-domain window, and receiving, by the wireless communication device from the base station, second signaling indicating modifying a conversion rule by which the frame structure is converted.

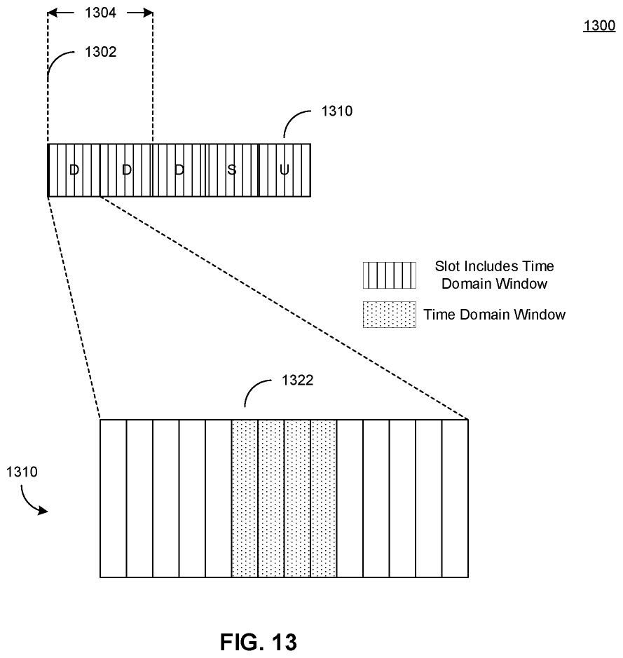

FIG. 13 is a signaling diagram illustrating a fourth cell level frame structure, according to various arrangements. As illustrated by way of example in FIG. 13, an example frame structure 1300 can include a plurality of symbols 1310 associated with a slot that includes a time domain window. The symbols 1310 can be associated with an offset 1302 and a period of a time domain window 1304. The symbol 1310 can include one or more portions 1320 outside the time domain window, and one or more portions 1322 within the time domain window.

As another example also shown in FIG. 13, the cell level frame structure is configured as ‘DDDSU’ with a period of 5 slots, the time domain window is configured with a period of 28 symbols (e.g., 2 slots), starting symbol(s) index within a period defined as 0000010 0000000 0000010 0000000, and a length of 4 symbols. The frame structure 800 can be configured via RRC signaling ‘tdd-UL-DL-ConfigurationCommon.’

As one example, the starting symbol(s) index within a slot is a bitmap with number of bits equal to number of symbols (or slots) within the period. As one example, the bits can be equal to 28 bits or 2 bits. The first symbol(s) of the time domain window within a period can be indicated via this parameter. The value ‘0000010 0000000 0000100 0000000’ represents the sixth symbol and the nineteenth symbol within each period, configured as the first symbols of the time domain windows. Thus, in this example, there are two time domain window within a period. Here, each of the time domain windows contains 4 symbols according to the configuration of a length of 4 symbols.

In some aspects, the period of the time-domain window is a first number of time intervals, the starting of the time-domain window defined by a time interval index or a bitmap that maps a number of bits equal to the first number of the time intervals, and the length of the time-domain window is a second number of time intervals. As one example, the period of the time domain is less than a period of the frame structure. As another example, the offset of the time domain is 0. As another example, the length of the time-domain window is a second number of time intervals. As another example, the offset of the time-domain window is a second number of the first time intervals. As another example, the starting of the time-domain window is defined by a time interval index or a bitmap that maps a number of bits equal to the first number of the time intervals.

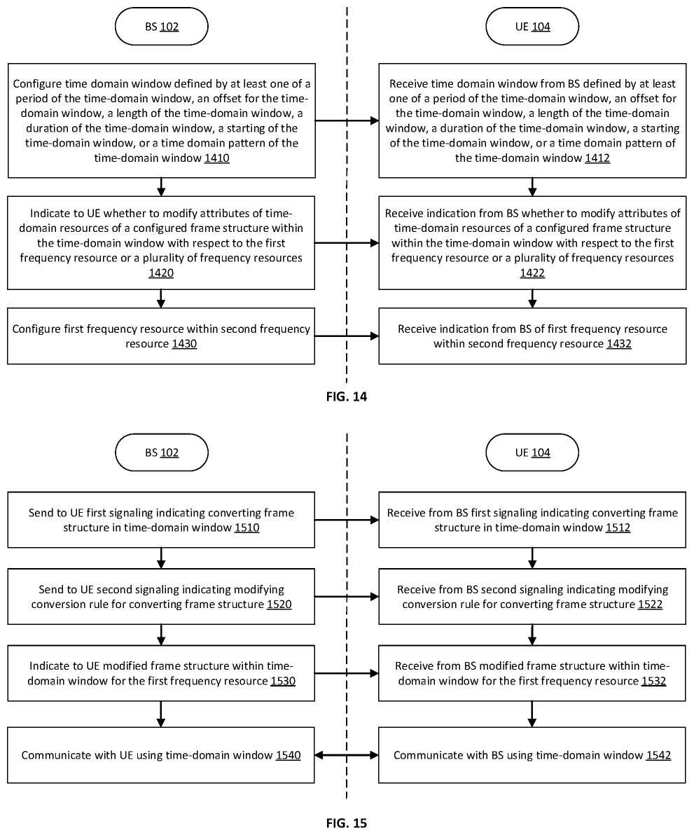

FIG. 14 is a diagram illustrating an example method for transmission source indication, according to various arrangements. At least one of the system 100, system 200, BS 102, and UE 104 can perform method 600 according to present implementations. The method 1400 can begin at 1410.

At 1410, the method can configure a time domain window defined by at least one of a period of the time-domain window, an offset for the time-domain window, a length of the time-domain window, a duration of the time-domain window, a starting of the time-domain window, or a time domain pattern of the time-domain window. The method 1400 can then continue to 1412 and 1420.

At 1412, the method can receive a time domain window from BS defined by at least one of a period of the time-domain window, an offset for the time-domain window, a length of the time-domain window, a duration of the time-domain window, a starting of the time-domain window, or a time domain pattern of the time-domain window. The method 1400 can then continue to 1422.

At 1420, the method can indicate to UE whether to modify attributes of time-domain resources of a configured frame structure within the time-domain window with respect to the first frequency resource or a plurality of frequency resources. The method 1400 can then continue to 1422 and 1430.

At 1422, the method can receive an indication from BS whether to modify attributes of time-domain resources of a configured frame structure within the time-domain window with respect to the first frequency resource or a plurality of frequency resources. The method 1400 can then continue to 1432.

At 1430, the method can configure a first frequency resource within a second frequency resource. The method 1400 can then continue to 1432, and can continue to FIG. 15.

At 1432, the method can receive an indication from BS of first frequency resource within second frequency resource. The method 1400 can end at 1432 or then continue to FIG. 15.

FIG. 15 is a diagram illustrating an example method for transmission source indication, according to various arrangements. At least one of the system 100, system 200, BS 102, and UE 104 can perform method 1500 according to present implementations. The method 1400 can begin at 1510.

At 1510, the method can send to UE first signaling indicating converting a frame structure in a time-domain window. The method can continue from 1430 of FIGS. 14 to 1510. The method 1500 can then continue to 1512 and 1520. At 1512, the method can receive from BS first signaling indicating converting a frame structure in a time-domain window. The method can continue from 1432 of FIGS. 14 to 1512. The method 1500 can then continue to 1522.

At 1520, the method can send to UE second signaling indicating modifying a conversion rule for converting a frame structure. The method 1500 can then continue to 1522 and 1530. At 1522, the method can receive from BS second signaling indicating modifying a conversion rule for converting a frame structure. The method 1500 can then continue to 1532.

At 1530, the method can indicate to UE a modified frame structure within a time-domain window for the first frequency resource. The method 1500 can then continue to 1532 and 1540. At 1532, the method can receive from BS a modified frame structure within a time-domain window for the first frequency resource. The method 1500 can then continue to 1542.

At 1540, the method can communicate with UE using a time-domain window. The method 1500 can then continue to 1542. At 1542, the method can communicate with BS using a time-domain window. The method 1500 can end at 1542 or then continue to 1540.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

1. A wireless communication method comprising:
configuring, by a base station for a wireless communication device, a time-domain window, wherein the time-domain window is defined by at least one of a period of the time-domain window, an offset for the time-domain window, a length of the time-domain window, a duration of the time-domain window, a starting of the time-domain window, or a time domain pattern of the time-domain window;
communicating, by the base station with the wireless communication device, using the time-domain window.

2. The wireless communication method of claim 1, wherein the time-domain window is determined for a cell.

3. The wireless communication method of claim 1, wherein the time-domain window is defined for a frequency resource.

4. The wireless communication method of claim 1, wherein
the period of the time-domain window is a first number of time intervals;
the offset of the time-domain window is a second number of the time intervals from a start of the period of the time-domain window; and
the length of the time-domain window is a third number of the time intervals.

5. The wireless communication method of claim 1, wherein
the period of the time-domain window is a first number of time intervals;
the offset of the time-domain window is 0; and
the length of the time-domain window equals to the period of the time-domain window.

6. The wireless communication method of claim 1, wherein
the period of the time-domain window is a first number of first time intervals;
the offset of the time-domain window is a second number of the first time intervals;
the starting of the time-domain window within a first time interval is defined by a second time interval index or a bitmap;
the length of the time-domain window is a third number of second time intervals; and
each of the first time intervals contains a plurality of the second time intervals;
the duration of the time-domain window indicates a fourth number of the first time intervals, which contains the time-domain window.

7. The wireless communication method of claim 1, wherein
the period of the time-domain window is a first number of time intervals;
the starting of the time-domain window defined by a time interval index or a bitmap that maps a number of bits equal to the first number of the time intervals; and
the length of the time-domain window is a second number of time intervals.

8. The wireless communication method of claim 1, wherein determining the time-domain window comprises excluding from the time-domain window one or more of:
at least one symbol for transmitting Synchronization Signal Block (SSB);
at least one symbol for a Control Resource Set (CORESET);
at least one symbol for Physical Random Access Channel (PRACH) transmission;
at least one symbol for Reference Signal (RS) transmission;
at least one symbol for control channel transmission;
at least one semi-static uplink resource according to frame structure configuration;
at least one semi-static downlink resource according to frame structure configuration;
at least one dynamic uplink resource;
at least one dynamic downlink resource; or
at least one dynamic flexible resource.

9. The wireless communication method of claim 1, wherein the time-domain window is determined as a time domain resource by including at least one first time-domain resource or excluding at least one second time-domain resource.

10. The wireless communication method of claim 9, wherein the at least one second time-domain resource carries a type of signal or channel.

11. The wireless communication method of claim 9, wherein
the at least one first time-domain resource comprises first ones of resources comprising a semi-static downlink resource, a semi-static uplink resource, a semi-static flexible resource, a dynamic downlink resource, a dynamic uplink resource, and a dynamic flexible resource.

12. The wireless communication method of claim 1, wherein
the time domain pattern comprises an ON phase and an OFF phase;
a configured frame structure is used during the ON phase; and
the time-domain window is defined by the OFF phase.

13. The wireless communication method of claim 1, further comprising indicating, by the base station to the wireless communication device, whether to modify attributes of time-domain resources of a configured frame structure within the time-domain window with respect to each of a plurality of frequency resources.

14. The wireless communication method of claim 1, further comprising indicating, by the base station to the wireless communication device, a modified frame structure used within the time-domain window with respect to each of a plurality of frequency resources.

15. The wireless communication method of claim 1, further comprising:
configuring a first frequency resource within a second frequency resource;
indicating, by the base station to the wireless communication device, a frame structure used within the time-domain window for the first frequency resource.

16. The wireless communication method of claim 15, further comprising:
indicating, by the base station to the wireless communication device, whether to modify attributes of time-domain resources of a configured frame structure within the time-domain window for the first frequency resource; or
indicating, by the base station to the wireless communication device, a modified frame structure used within the time-domain window for the first frequency resource.

17. The wireless communication method of claim 1, further comprising:
sending, by the base station to the wireless communication device, first signaling indicating converting a frame structure within the time-domain window; and
sending, by the base station to the wireless communication device, second signaling indicating modifying a conversion rule by which the frame structure is converted.

18. A wireless communication method, comprising:
receiving, by a wireless communication device from a base station, a time-domain window, wherein the time-domain window is defined by at least one of a period of the time-domain window, an offset for the time-domain window, a length of the time-domain window, a duration of the time-domain window, a starting of the time-domain window, or a time domain pattern of the time-domain window;
communicating, by the wireless communication device with the base station, using the time-domain window.

19. A base station, comprising:
at least one processor configured to:
configure, for a wireless communication device, a time-domain window, wherein the time-domain window is defined by at least one of a period of the time-domain window, an offset for the time-domain window, a length of the time-domain window, a duration of the time-domain window, a starting of the time-domain window, or a time domain pattern of the time-domain window;
communicate, via a transceiver with the wireless communication device, using the time-domain window.

20. A wireless communication device, comprising:
at least one processor configured to:
receive, via a transceiver from a base station, a time-domain window, wherein the time-domain window is defined by at least one of a period of the time-domain window, an offset for the time-domain window, a length of the time-domain window, a duration of the time-domain window, a starting of the time-domain window, or a time domain pattern of the time-domain window;
communicate, via the transceiver with the base station, using the time-domain window.
